(19) United States
(12) Patent Application Publication
(10) Pub. No.: US 2019/0108564 A1
(43) Pub. Date: Apr. 11, 2019

(54) Automated Methods for Exposing Stolen and Counterfeit Goods on Walmart.com and other Ecommerce Sites

(71) Applicant: Mary Elizabeth Goulet, Mclean, VA (US)

(72) Inventor: Mary Elizabeth Goulet, Mclean, VA (US)

(21) Appl. No.: 15/814,486

(22) Filed: Nov. 16, 2017

Related U.S. Application Data
(60) Provisional application No. 62/568,696, filed on Oct. 5, 2017.

(51) Int. Cl. G06Q 30/06; G06F 17/30; H04L 29/06

(52) U.S. Cl. CPC G06Q 30/0609; H04L 63/08; G06F 17/30887

(57) ABSTRACT

Computerized technology for automated brand protection services is provided, exposing walmart.com's nefarious third party sellers. The computerized technology exposes third party sellers on walmart.com who sell counterfeit, expired and/or stolen product. The computerized technology also exposes walmart.com URLs that have a high likelihood of offering counterfeit, expired, and/or stolen product.

### FIELD OF THE INVENTION

The invention relates to e-commerce, particularly to walmart.com.

### BACKGROUND OF THE INVENTION

Recently Walmart launched walmart.com, by now featuring many, on the order of millions, of URLs offering products for sale by a third party who is not Walmart. Generally speaking, when consumers see a seller/shipper name, other than Walmart, listed as the Seller/Shipper Name on a webpage on walmart.com, they assume that to be a division or affiliate of Walmart, and they are without thoughts that it could be someone fencing stolen goods or offering counterfeit or expired goods. Consumers are unsuspicious of low prices if Walmart is involved, because they assume that Walmart, being so uniquely big, buys from manufacturers in vast quantities.

Especially in the case of cosmetics or products that consumers apply to their bodies or consume, they want to avoid something that is of shady origin and could be counterfeit, expired, stolen or adulterated.

More generally, in the case of all kinds of merchandise, consumers do not want counterfeiters or fencers of stolen merchandise or other crooks to know their names and home addresses, that the crooks can obtain in connection with their getting data from Walmart.com in order for them to ship the orders gotten via walmart.com.

Even when a brand owner notifies Walmart that there is a problem on walmart.com with stolen/expired goods and counterfeit goods, Walmart continues selling.

There are unmet needs for technology for protecting consumers against being sold nefarious goods via walmart.com.

There are unmet needs for technology useable by brand owners to prevent counterfeits, stolen goods, expired goods, and such from being sold on walmart.com and other ecommerce websites.

### SUMMARY OF THE INVENTION

The above-mentioned problems are addressed by automated technology by which a computer collects URLs from walmart.com or other website displaying seller/shipper names, and performs processing steps.

The invention in one preferred embodiment provides a method of exposing an ecommerce website (such as walmart.com)'s sellers who are selling counterfeit, expired and/or stolen product and exposing walmart.com webpages with nefarious selling, comprising steps (each performed by a computer): collecting URLs (such as walmart.com URLs) for webpages on which a product is sold and a Seller/Shipper name is displayed; storing the collected URLs; for a URL collected and stored, scraping the Seller/Shipper Name from the URL and using the scraped name as Name1 to begin a Seller Aliasing Table; and for a stored URL, revisiting the URL at a later point in time and scraping the Seller/Shipper Name currently displayed, followed by comparing the currently displayed Seller/Shipper name to Seller Name1 stored for the URL, such as, e.g., inventive methods wherein, in the comparing step, if the names differ, storing the new Seller Name as Alias1 in the Seller Aliasing Name Table for the URL (such as, e.g., inventive methods wherein if the Seller Name is different at time2 than time1 on a URL, storing an image of the webpage; inventive methods further comprising repeating the visiting the URL and the scraping of the current seller name, and comparing the now-current seller name against Name1 and/or Alias1, and if different, building Alias2 into the Seller Aliasing Table; inventive methods further comprising, when the computer determines that a Name1 has a non-null entry for Alias1, assigning an Aliasing Seller control # and populating a table for the Aliasing Seller having that control #; etc.); inventive methods operated in conjunction with an app useable by shoppers whereby a device of the shopper submits to the computer a URL on which the shopper is contemplating a purchase transaction, and the computer communicates a message to the device of the shopper about the URL and/or the seller name displayed on the URL (such as, e.g., inventive methods wherein for a URL that has stored therefor at least one alias Alias1 . . . n in addition to Name1, the communicated message is a warning; inventive methods wherein the computer performs scraping of the seller name from the URL on which the shopper is contemplating a purchase transaction in order, followed by comparing the scraped seller name against stored aliasing records, and if the scraped seller name is found in an aliasing table, communicating a warning message to the device of the shopper); inventive methods further comprising operating a portal into which is received a seller name being queried by a brand owner or other interested party in a querying step, and in response to the querying step, outputting a list of aliases for the seller name being queried; inventive methods further comprising operating a portal into which are received repudiation reports submitted by a brand owner, wherein the repudiation report comprises a brand name and at least one website for which the brand owner repudiates purported sales (such as inventive methods further comprising the computer's processing the repudiation report into a warning communication (such as, e.g., a warning communication in a format “this brand isn't sold on walmart.com”) delivered to at least one shopper); and other inventive methods.

### BRIEF DESCRIPTION OF THE DRAWINGS

FIG. 1 is an Aliasing Seller table, control#1, according to an inventive automated processing method in which Aliasing Seller tables for control#1 . . . n are constructed over a period of time, usually at least days, by a computer.

FIG. 1A is the Aliasing Seller table of FIG. 1 after further aliases have been detected and added.

FIG. 2 is printed from the walmart.com URL https://www.walmart.com/ip/CHANEL-No-5-by-Chanel-Women-Eau-De-Parfum-Spray-1-7-oz/877941784 where, on screen, “Sold & shipped by” is in black; “BuyDBest Incorporated” is in blue and bolded.

### DETAILED DESCRIPTION OF A PREFERRED EMBODIMENT OF THE INVENTION

The invention in a preferred embodiment uses a computer to perform a step of collecting URLs from an online retailer who displays a name of a seller/shipper in connection with a product offered for sale, such as walmart.com.

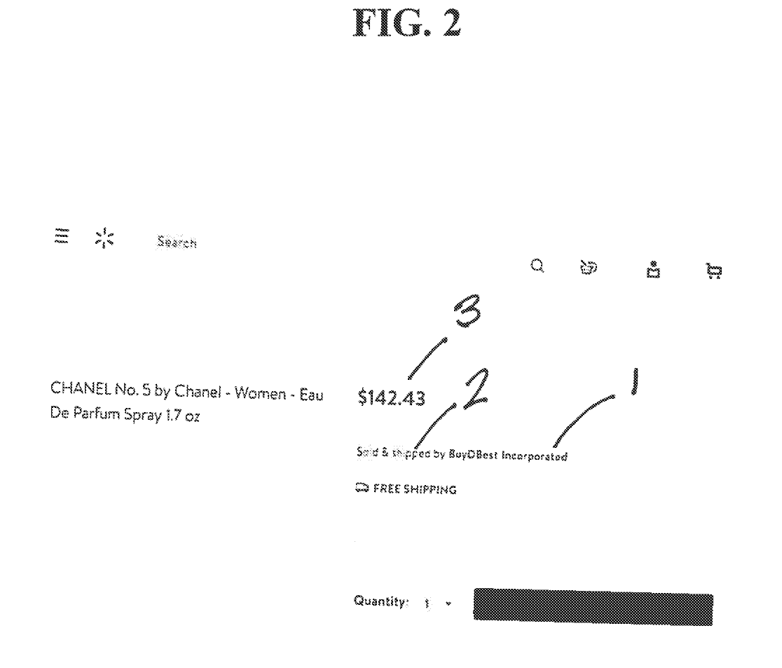

For the computer to begin collecting URLs, one approach is to initiate URL-collection based on a brand name received by the computer as input. For example, for a computer on Nov. 5, 2017 initiating URL-collection based on a brand name “Chanel” received as input, https://www.walmart.com/ip/CHANEL-No-5-by-Chanel-Women-Eau-De-Parfum-Spray-1-7-oz/877941784 (see FIG. 2) is a collected URL. Other approaches may be used for the computer to begin URL-collection, such as the computer searching for “cosmetics” or other product likely to be e-fenced after having been stolen, likely to be counterfeited, likely to be sold in expired state, etc.

As URLs are collected by the computer, the computer stores the collected URLs, such as along the lines of Examples 1A-1CK. The collected URL is stored so that the computer can revisit the URL on future days.

Preferably, the computer stores an image of the URL at the collection time. The invention can be practiced without storing the webpage images, but having the stored images will make a better presentation when the very same URL at two points in time can be shown to have a different Seller/Shipper.

For each URL, the computer scrapes the Seller Name (which can also be called Shipper Name, or “Sold and Shipped by”, or such) from the Seller Name Area 1 and uses the scraped name to begin a Seller Aliasing Table, such as by scraping the Seller Name and storing it into a Name1 field for the URL. Referring to FIG. 2, the Seller Name Area 1 is where the words “BuyDBest Incorporated” appear, after the fixed text “Sold & shipped by” 2 under the price 3.

For a stored URL, the computer revisits the URL at a later point in time, and scrapes the Seller Name currently displayed. The computer compares the currently displayed seller name in the Seller Name Area 1 to Name1 stored for the URL. If the names differ, the computer stores the new Seller Name 1 as Alias1 in the Seller Aliasing Name Table for the URL; preferably the computer also, in the case of differing Seller Name at time1 and time2, stores an image of the webpage at time2.

By “Seller Alias”, what is meant is a shipper/seller whose name is displayed on an URL in the Seller Name 1 area as one name at a first point in time, and at a later point in time, on the very same URL in the Seller Name 1 area, is displayed as a different name. The different names used, when Seller Aliasing occurs over time on a URL, may or may not be actual business entities. Namely, whether the displayed seller/shipper name is an actual corporate or business entity (such as registered with a state corporations department) is NOT dispositive of whether Seller Aliasing is occurring or not on a URL.

Preferably, the computer revisits URLs not just at time2 but at further subsequent times. For revisiting URLs, the computer gives higher priority to a URL that has already yielded an alias. Sometimes the computer might find that an URL is inaccessible, which might seem to reflect deletion. However, preferably the computer is skeptical and attempts the URL again repeatedly in the future, and may very well find that the URL disappears and reappears with a new seller alias.

Preferably the computer repeats the visits to an URL for which has been built a table that has Alias1 in addition to Name1, repeats the scraping of the current seller name, and compares the current seller name against Name1 and/or Alias1, and if different, the computer builds Alias2 into the Seller Aliasing Table.

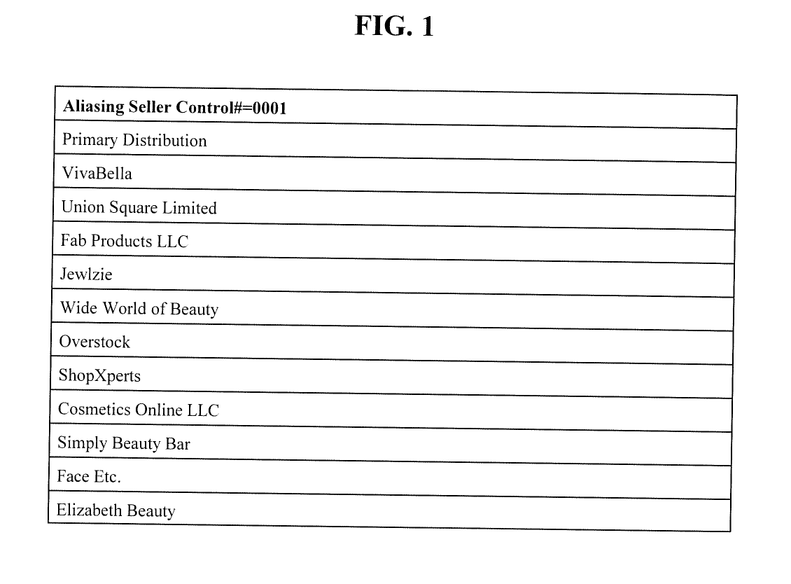

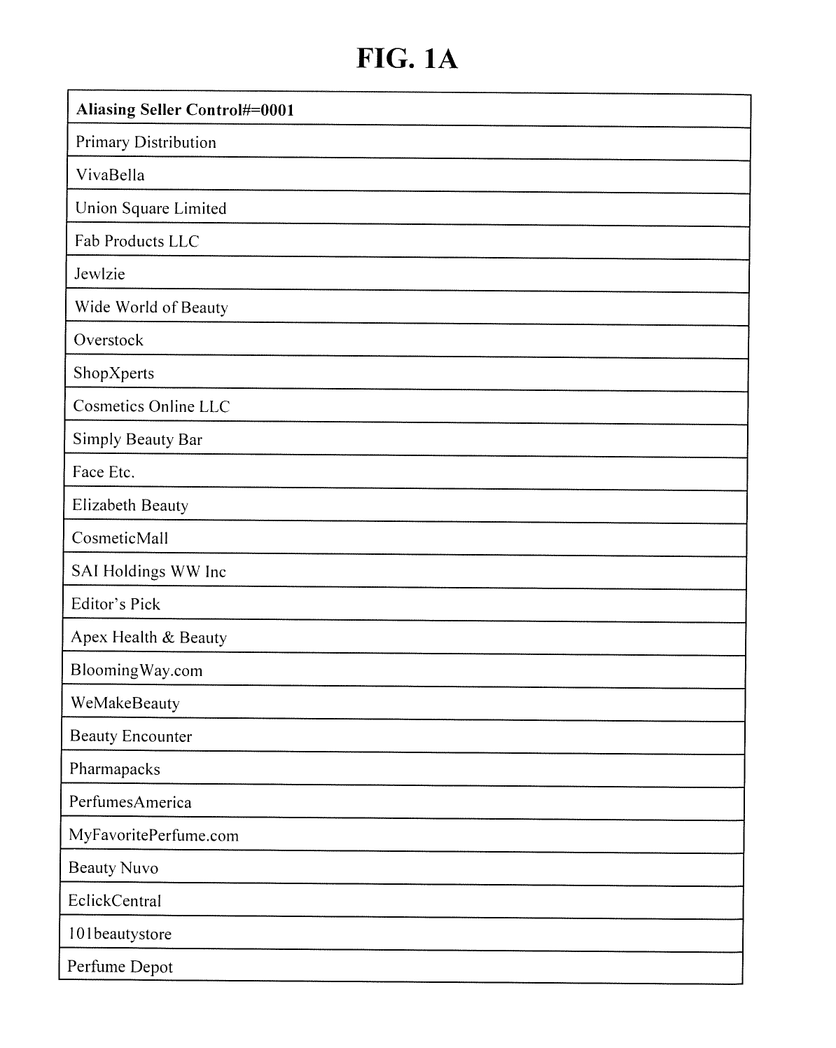

The invention is useable to produce computer-generated tables of Aliasing Sellers by control # (such as FIG. 1) or other format, as well as computer-generated tables of URLs on which the Seller/Shipper is an Aliasing Seller, which in turn are useable by the computer in various embodiments.

In one embodiment, a consumer activates a service by which the computer compares a webpage on which the consumer is contemplating a purchase, against the tables in the computer, and returns a visual warning report to the consumer if the URL has an Aliasing Seller, or if the Seller for URL is an Aliasing Seller generally even if not yet aliasing on that URL.

In another embodiment, a brand owner activates a service by which the computer sends reports to the brand owner on which URLs have the brand and either have undergone Seller Aliasing or have a seller named who is carrying out Seller Aliasing on another URL which can be a URL relating to a different brand.

In a further embodiment, the computer further operates a portal into which are received repudiations by a brand owner, such as a report that all instances of BLINC cosmetics on walmart.com are repudiated by the brand owner. Preferably the portal into which are received repudiations by a brand owner has fields for multiple websites to be reported (regardless of whether or not the computer is performing URL collection and processing steps against that website), such as a report that all instances of BLINC cosmetics on walmart.com, jet.com, overstock.com and iglow.no are repudiated by the brand owner.

Walmart.com webpages display a Seller/Shipper, and so the inventive methods are particularly suited for use in connection with walmart.com URLs and webpages, but the inventive methods can be used with other ecommerce websites that have at least some, but not necessarily all, webpages that display Seller/Shipper name.

The invention may be appreciated from the following examples without being limited thereto.

### Example 1 (Collecting URLs)

A computer performs a step of collecting URLs from walmart.com, and stores the collected URLs such as Examples 1A-1CK.

### Example 1A

https://www.walmart.com/ip/Blinc-Mascara-Black-21-oz/129729006

### Example 1B

https://www.walmart.com/ip/Blinc-Dark-Brown-Mascara/18485901

### Example 1C

https://www.walmart.com/ip/blinc-eyebrow-mousse-black145850568

### Example 1D

https://www.walmart.com/ip/AsWeChange-Dark-Blonde-Blinc-Eyebrow-Mousse-0.14-Oz./39571980

### Example 1E

https://www.walmart.com/ip/blinc-heated-lash-curler/182714321

### Example 1F

https://www.walmart.com/ip/Blinc-Grey-Eyebrow-Mousse/111807094

### Example 1G

https://www.walmart.com/ip/AsWeChange-Light-Tone-Blinc-Eye-Shadow-Primer/39572143

### Example 1H

https://www.walmart.com/ip/blinc-eyebrow-mousse-dark-brunette/181760980

### Example 1I

https://www.walmart.com/ip/Blinc-Shadow-Fusion-Palette/161469105

### Example 1J

https://www.walmart.com/ip/-Black-Blinc-Ultrathin-Liquid-Eyeliner-Pen/39571414

### Example 1K

https://www.walmart.com/ip/blinc-Lash-Primer-Black/155335568

### Example 1L

https://www.walmart.com/ip/Blinc-Dark-Green-Mascara/105529977

### Example 1M

https://www.walmart.com/ip/Blinc-Medium-Blonde-Eyebrow-Mousse/121661017

### Example 1N

https://www.walmart.com/ip/AsWeChange-Light-Brown-Blinc-Eyebrow-Mousse-0.14-Oz./39571535

### Example 1O

https://www.walmart.com/ip/Blinc-Mascara-Black-6g-0-21oz/133726291

### Example 1P

https://www.walmart.com/ip/AsWeChange-Blinc-Eyebrow-Mousse/112650512

### Example 1Q

https://www.walmart.com/ip/AsWeChange-Blinc-Liquid-Eyeliner-Pen/44708512

### Example 1R

https://www.walmart.com/ip/AsWeChange-Medium-Brown-Blinc-Eyeliner/39571626

### Example 1S

https://www.walmart.com/ip/Blinc-Shadow-Blending-Brush/185188948

### Example 1T

https://www.walmart.com/ip/Blinc-Conditioner-for-Normal-or-Oily-Hair-12-oz/150343670

### Example 1U

https://www.walmart.com/ip/Blinc-Shadow-Primer-Brush/145019169

### Example 1V

https://www.walmart.com/ip/Blinc-Clear-Eyebrow-Mousse/116819674

### Example 1W

https://www.walmart.com/ip/blinc-eyebrow-mousse-light-blonde/101307678

### Example 1X

https://www.walmart.com/ip/AsWeChange-White-Blinc-Eyeliner-Pencil/44798494

### Example 1Y

https://www.walmart.com/ip/Blinc-Dark-Purple-Mascara/113193601

### Example 1Z

https://www.walmart.com/ip/AsWeChange-Purple-Blinc-Eyeliner-Pencil/46373163

### Example 1AA

https://www.walmart.com/ip/AsWeChange-Brown-Blinc-Eyeliner-Pencil/46373211

### Example 1AB

https://www.walmart.com/ip/Blinc-Eyeliner-Purple-0-21-oz/148121518

### Example 1AC

https://www.walmart.com/ip/AsWeChange-Blinc-Mascara-Amplified/46343021

### Example 1AD

https://www.walmart.com/ip/Blinc-Waterproof-Eyeliner-Pencil-Emerald-Eyeliner-For-Women/897223738

### Example 1AE

https://www.walmart.com/ip/AsWeChange-Flesh-Tone-Blinc-Eye-Shadow-Primer/39571976

### Example 1AF

https://www.walmart.com/ip/AsWeChange-Blue-Blinc-Eyeliner-Pencil/39572135

### Example 1AG

https://www.walmart.com/ip/AsWeChange-Grey-Blinc-Eyeliner/39571722

### Example 1AH

https://www.walmart.com/ip/Blinc-Dark-Blue-Mascara/149936276

### Example 1AI

https://www.walmart.com/ip/AsWeChange-Black-Blinc-Eyeliner/39572230

### Example 1AJ

https://www.walmart.com/ip/Blinc-Lash-Primer-0-23-oz/133805072

### Example 1AK

https://www.walmart.com/ip/Blinc-Long-Lash-5-3g-0-12oz/111632201

### Example 1AL

https://www.walmart.com/ip/Blinc-Conditioner-for-Dry-or-Treated-Hair-12-oz/125950393

### Example 1AM

https://www.walmart.com/ip/Blinc-Medium-Brown-Mascara/181279749

### Example 1AN

https://www.walmart.com/ip/Blinc-Brow-Liner-Duo-Cosmetic-Brush/45373065

### Example 1AO

https://www.walmart.com/ip/Blinc-Heated-Lash-Curler/45372871

### Example 1AP

https://www.walmart.com/ip/Blinc-Lash-Comb-Brush/50790868

### Example 1AQ

https://www.walmart.com/ip/Blinc-Contour-Shadow-Brush/138770225

### Example 1AR

https://www.walmart.com/ip/Blinc-Shadow-Blending-Brush/180521671

### Example 1AS

https://www.walmart.com/ip/Blinc-Shadow-Primer-Brush/146236674

### Example 1AT

https://www.walmart.com/ip/Blinc-Contour-Shadow-Brush/191002755

### Example 1AU

https://www.walmart.com/ip/Blinc-Shadow-Blending-Brush/191610161

### Example 1AU

https://www.walmart.com/ip/Blinc-Eyebrow-Mousse-Light-Blonde-4g-0-14oz/127818225

### Example 1AV

https://www.walmart.com/ip/Blinc-Brow-Liner-Duo-Brush/123477481

### Example 1AW

https://www.walmart.com/ip/Blinc-Liquid-Eyeliner-Pen-Black-0-7 ml-0-025oz/142606909

### Example 1AX

https://www.walmart.com/ip/Blinc-Micro-Trimmer-the-Power-Of-Precision/126225991

### Example 1AY

https://www.walmart.com/ip/Ultrathin-Liquid-Eyeliner-Pen/576034771

### Example 1AZ

https://www.walmart.com/ip/Liquid-Eyeliner-Pen/949852168

### Example 1BB

https://www.walmart.com/ip/Blinc-Shadow-Primer-Brush/180802496

### Example 1BC

https://www.walmart.com/ip/Blinc-Brow-Liner-Duo-Brush/146645393

### Example 1BD

https://www.walmart.com/ip/Blinc-Dark-Brown-Mascara-Amplified/175882713

### Example 1BE

https://www.walmart.com/ip/Blinc-Kiss-Me-Eyeliner-Color-Dark-Blue/146279187

### Example 1BF

https://www.walmart.com/ip/Blinc-Long-Lash/130310489

### Example 1BG

https://www.walmart.com/ip/Blinc-Eyeliner-Pencil-Grey-1-2-g-0-04-oz/39571545

### Example 1BH

https://www.walmart.com/ip/Shadow-Primer-Brush-by-Blinc-for-Women-1-Pc-Brush/152354174

### Example 1BI

https://www.walmart.com/ip/Contour-Shadow-Brush-by-Blinc-for-Women-1-Pc-Brush/949850263

### Example 1BJ

https://www.walmart.com/ip/Blinc-Cosmetic-Brush-Brow-Liner-DUO-Brush/174524563

### Example 1BK

https://www.walmart.com/ip/Blinc-Cosmetic-Brush-Lash-Comb/152608379

### Example 1BL

https://www.walmart.com/ipiShadow-Blending-Brush-by-Blinc-for-Women-1-Pc-Brush/641585975

### Example 1BM

https://www.walmart.com/ip/Blinc-Micro-Trimmer-Model-Le-717-Micro-Trimmer-For-Women/143004227

### Example 1BN

https://www.walmart.com/ip/Eyeliner-Pencil/39571671

### Example 1BO

https://www.walmart.com/ip/Blinc-Cosrnetic-Brow-and-Liner-Duo-Brush/330849094

### Example 1 BP

https://www.walmart.com/ip/All-Over-Shadow-Brush-by-Blinc-for-Wornen-1-Pc-Brush/205233651

### Example 1BQ

https://www.walmart.com/ip/Brow-Liner-Duo-Brush-by-Blinc-for-Wonen-1-Pc-Brush/973633062

### Example 1BR

https://www.walmart.com/ip/Blinc-Eyeliner/701452410

### Example 1BS

https://www.walmart.com/ip/Blinc-Eyeliner-Pencil/136415714

### Example 1BT

https://www.walmart.com/ip/Blinc-Eyeliner-Black-6g-0-21oz/110140160

### Example 1 BU

https://www.walmart.com/ip/Blinc-Eyeliner-Grey-6g-0-21oz/162672865

### Example 1BV

https://www.walmart.com/ip/Blinc-All-Over-Shadow-Brush/148237130

### Example 1 BW

https://www.walmart.com/ip/Blinc-Heated-Lash-Curler/186085856

### Example 1 BX

https://www.walmart.com/ip/Blinc-Eyebrow-Mousse-Light-Brunette-4g-0-14oz/148545068

### Example 1BY

https://www.walmart.com/ip/Blinc-Lash-Primer/123725621

### Example 1BZ

https://www.walmart.com/ip/Blinc-Eye-Shadow-Primer/139407029

### Example 1CC

https://www.walmart.com/ip/Blinc-Eyeliner-Dark-Bue-6g-0-21oz/163399959

### Example 1 CD

https://www.walmart.com/ip/Blinc-Eyebrow-Mousse-Dark-Blonde-4g-0-14oz/199566930

### Example 1 CE

https://www.walmart.com/ip/Blinc-Heated-Lash-Curler/106368549

### Example 1CF

https://www.walmart.com/ip/Blinc-Eyebrow-Mousse-Auburn-4g-0-14oz/140383270

### Example 1CG

https://www.walmart.com/ip/Blinc-Eyebrow-Mousse-Dark-Brunette-4g-0-14oz/103402597

### Example 1CH

https://www.walmart.com/ip/Blinc-Mascara/726015057

### Example 1CI

https://www.walmart.com/ip/Blinc-Eyeliner-Pencil/465300883

### Example 1 CJ

https://www.walmart.com/ip/Blinc-Eyeliner/702411263

### Example 1CK

https://www.walmart.com/ip/Eyebrow-Mousse/315630348

### Example 2 (Building Name1 in a Seller-Aliasing Table for a Walmart.com URL)

For a walmart.com URL collected and stored, such as the URLs in Example 1, the computer scrapes the Seller Name from the URL and uses the scraped name to begin a Seller Aliasing Table.

### Example 2.1

For the URL, https://www.walmart.com/ip/Blinc-Mascara-Black-21-oz/129729006 (Example 1A),

### Name1=Union Square Limited

### Example 2.2

For the URL, https://www.walmart.com/ip/Blinc-Dark-Brown-Mascara/118485901 (Example 1B),

### Name1=VivaBella

### Example 2.3

For the URL, https://www.walmart.com/ip/blinc-eyebrow-mousse-black/145850568 (Example 1C),

### Name1=Primary Distribution

### Example 2.4

For Example 1D's URL, https://www.walmart.com/ip/AsWeChange-Dark-Blonde-Blinc-Eyebrow-Mousse-0.14-Oz./39571980,

### Name1=VivaBella

### Example 2.5

For URL, https://www.walmart.com/ip/blinc-eyebrow-mousse-dark-brunette/181760980 (Example 1H),

### Name1=VivaBella

### Example 2.6

For URL https://www.walmart.com/ip/Blinc-Shadow-Fusion-Palette/161469105 (Example 1I),

### Name1=VivaBella

### Example 2.7

For Example 1J's URL https://www.walmart.com/ip/-Black-Blinc-Ultrathin-Liquid-Eyeliner-Pen/39571414,

### Name1=Union Square Limited

### Example 2.8

For Example 1M's URL https://www.walmart.com/ip/Blinc-Medium-Blonde-Eyebrow-Mousse/121661017,

### Name1=Fab Products LLC

### Example 2.9

For Example 1M's URL https://www.walmart.com/ip/Blinc-Medium-Blonde-Eyebrow-Mousse/121661017,

### Name1=Fab Products LLC

### Example 2.10

For Example 1N's URL https://www.walhnart.com/ip/AsWeChange-Light-Brown-Blinc-Eyebrow-Mousse-0.14-Oz./39571535 Name1=Union Square Limited

### Example 2.11

For URL https://www.walmart.com/ip/Blinc-Shadow-Blending-Brush/185188948 (Example 1S),

### Name1=Cosmetic Mall

### Example 2.12

For URL https://www.walmart.com/ip/Blinc-Shadow-Primer-Brush/145019169 (Example 1U),

### Name1=Overstock

### Example 2.13

For URL https://www.walmart.com/ip/blinc-eyebrow-mousse-light-blonde/101307678 (Example 1 W),

### Name1=Wide World of Beauty

### Example 2.14

For URL https://www.walmart.com/ip/AsWeChange-Purple-Blinc-Eyeliner-Pencil/46373163 (Example 1Z),

### Name1=VivaBella

### Example 2.15 For URL

https://www.walnmart.com/ip/AsWeChange-Brown-Blinc-Eyeliner-Pencil/46373211 (Example 1AA), Name1=Union Square Limited

### Example 2.16

For URL https://www.walmart.com/ip/Blinc-Eyeliner-Purple-0-21-oz/148121518 (Example 1AB), Name1=Fab Products LLC

### Example 2.17

For Example 1AD's URL https://www.walmart.com/ip/Blinc-Waterproof-Eyeliner-Pencil-Emerald-Eyeliner-For-Women/897223738 Name1=VivaBella

### Example 2.18

For URL https://www.walmart.com/ip/AsWeChange-Flesh-Tone-Blinc-Eye-Shadow-Primer/39571976 (Example 1AE),

### Name1=Union Square Limited

### Example 2.19

For URL https://www.walmart.com/ip/AsWeChange-Blue-Blinc-Eyeliner-Pencil/39572135 (Example 1AF),

### Name1=VivaBella

### Example 2.20

For URL https://www.walmart.com/ip/Blinc-Lash-Primer-0-23-oz/133805072 (Example 1AJ),

### Name1=Fab Products, LLC

### Example 2.21

For URL https://www.walmart.com/ip/Blinc-Long-Lash-5-3g-0-2oz/111632201 (Example 1AK),

### Name1=Jewlzie

### Example 2.22

For Example 1AL's URL https://www.walmart.com/ip/Blinc-Conditioner-for-Dy-or-Treated-Hair-12-oz/125950393,

### Name1=Fab Products LLC

### Example 2.23

For URL https://www.walmart.com/ip/Blinc-Medium-Brown-Mascara/181279749 (Example 1AM),

### Name1=VivaBella

### Example 2.24

For Example 1AN's URL https://www.walmart.com/ip/Blinc-Brow-Liner-Duo-Cosmetic-Brush/45373065,

### Name1=Overstock

### Example 2.25

For URL https://www.walmart.com/ip/Blinc-Heated-Lash-Curler/45372871 (Example 1 AO),

### Name1=Overstock

### Example 2.26

For URL https://www.walmart.com/ip/Blinc-Lash-Comb-Brush/50790868 (Example 1AP),

### Name1=Overstock

### Example 2.27

For URL https://www.walmart.com/ip/Blinc-Contour-Shadow-Brush/138770225 (Example 1AQ),

### Name1=Overstock

### Example 2.28

For URL https://www.walmart.com/ip/Blinc-Shadow-Blending-Brush/180521671 (Example 1AR),

### Name1=Overstock

### Example 2.29

For URL https://www.walmart.com/ip/Blinc-Shadow-Primer-Brush/146236674 (Example 1AS),

### Name1=Jewlzie

### Example 2.30

For URL https://www.walmart.com/ip/Blinc-Contour-Shadow-Brush/191002755 (Example 1AT),

### Name1=Jewlzie

### Example 2.31

For URL https://www.walmart.com/ip/Blinc-Shadow-Blending-Brush/191610161 (Example 1AU),

### Name1=Jewlzie

### Example 2.32

For Example 1AU's URL, https://www.walmart.com/ip/Blinc-Eyebrow-Mousse-Light-Blonde-4g-0-14oz/127818225,

### Name1=Jewlzie

### Example 2.33

For URL https://www.walmart.com/ip/Blinc-Brow-Liner-Duo-Brush/123477481 (Example 1AV),

### Name1=Jewlzie

### Example 2.34

For Example 1AW's URL https://www.walmart.com/ip/Blinc-Liquid-Eyeliner-Pen-Black-0-7 ml-0-025oz/142606909,

### Name1=Jewlzie

### Example 2.35

For Example 1AX's URL, https://www.walmart.com/ip/Blinc-Micro-Trimmer-the-Power-Of-Precision/126225991,

### Name1=Cosmetic Mall

### Example 2.35

For URL https://www.walmart.com/ip/Ultrathin-Liquid-Eyeliner-Pen/576034771 (Example 1AY),

### Name1=Cosmetic Mall

### Example 2.36

For URL https://www.walmart.com/ip/Liquid-Eyeliner-Pen/949852168 (Example 1AZ),

### Name1=Cosmetic Mall

### Example 2.37

For URL https://www.walmart.com/ip/Blinc-Shadow-Primer-Brush/180802496 (Example 1BB),

### Name1=Bloomingway.com

### Example 2.38

For URL https://www.walmart.com/ip/Blinc-Brow-Liner-Duo-Brush/146645393 (Example 1BC),

### Name1=Bloomingway.com

### Example 2.39

For Example 1BD's URL, https://www.walmart.com/ip/Blinc-Dark-Brown-Mascara-Amplified/175882713,

### Name1=Fab Products LLC

### Example 2.40

For URL https://www.walmart.com/ip/Blinc-Eyeliner-Pencil-Grey-1-2-g-0-04-oz/39571545 (Example 1BG),

### Name1=Fab Products LLC

### Example 2.41

For Example 1BH's URL, https://www.walmart.com/ip/Shadow-Primer-Brush-by-Blinc-for-Women-1-Pc-Brush/152354174,

### Name1=VivaBella.

### Example 2.42

For Example 1BI's URL https://www.walmart.com/ip/Contour-Shadow-Brush-by-Blinc-for-Women-1-Pc-Brush/949850263,

### Name1=VivaBella.

### Example 2.43

For Example 1BJ's URL, https://www.walmart.com/ip/Blinc-Cosmetic-Brush-Brow-Liner-DUO-Brush/174524563,

### Name1=Fab Products LLC

### Example 2.44

For Example 1BK's URL, https://www.walmart.com/ip/Blinc-Cosmetic-Brush-Lash-Comb/152608379

### Name1=Fab Products LLC

### Example 2.45

For Example 1BL's URL, https://www.walmart.com/ip/Shadow-Blending-Brush-by-Blinc-for-Women-1-Pc-Brush/641585975,

### Name1=VivaBella.

### Example 2.46

For Example 1BM's URL, https://www.walmart.com/ip/Blinc-Micro-Trimmer-Model-Le-717-Micro-Trimmer-For-Women/143004227

### Name1=Fab Products LLC

### Example 2.47

For Example 1BN's URL, https://www.walmart.com/ip/Eyeliner-Pencil/39571671

### Name1=Union Square Limited

### Example 2.48

For Example 1BO's URL, https://www.walmart.com/ip/Blinc-Cosmetic-Brow-and-Liner-Duo-Brush/330849094

### Name1=MODAMAD

### Example 2.49

For Example 1BP's URL, https://www.walmart.com/ip/All-Over-Shadow-Brush-by-Blinc-for-Women-1-Pc-Brush/205233651

### Name1=VivaBella

### Example 2.50

For Example 1BQ's URL, https://www.walmart.com/ip/Brow-Liner-Duo-Brush-by-Blinc-for-Women-1-Pc-Brush/973633062

### Name1=VivaBella

### Example 2.51

For Example 1BR's URL, https://www.walmart.com/ip/Blinc-Eyeliner/701452410

### Name1=Cosmetic Mall

### Example 2.52

For Example 1BS's URL, https://www.walmart.com/ip/Blinc-Eyeliner-Pencil/136415714

### Name1=Cosmetic Mall

### Example 2.53

For Example 1BT's URL, https://www.walmart.com/ip/Blinc-Eyeliner-Black-6g-0-21oz/110140160

### Name1=Jewlzie

### Example 2.54

For Example 1BU's URL, https://www.walmart.com/ip/Blinc-Eyeliner-Grey-6g-0-21oz/162672865

### Name1=Jewlzie

### Example 2.55

For Example 1BV's URL, https://www.walmart.com/ip/Blinc-All-Over-Shadow-Brush/148237130

### Name1=Jewlzie

### Example 2.56

For Example 1BW's URL, https://www.walmart.com/ip/Blinc-Heated-Lash-Curler/186085856

### Name1=Cosmetic Mall

### Example 2.57

For Example 1BX's URL, https://www.walmart.com/ip/Blinc-Eyebrow-Mousse-Light-Brunette-4g-0-4oz/148545068

### Name1=Jewlzie

### Example 2.58

For Example 1BY's URL, https://www.walmart.com/ip/Blinc-Lash-Primer/123725621

### Name1=Cosmetic Mall

### Example 2.59

For Example 1BZ's URL, https://www.walmart.com/ip/Blinc-Eye-Shadow-Primer/139407029

### Name1=Cosmetic Mall

### Example 2.60

For Example 1CC's URL, https://www.walmart.com/ip/Blinc-Eyeliner-Dark-Blue-6g-0-21oz/163399959

### Name1=Jewlzie

### Example 2.61

For Example 1CD's URL, https://www.walmart.com/ip/Blinc-Eyebrow-Mousse-Dark-Blonde-4g-0-14oz/199566930

### Name1=Jewlzie.

### Example 2.62

For Example 1CE's URL, https://www.walmart.com/ip/Blinc-Heated-Lash-Curler/106368549

### Name1=Jewlzie

### Example 2.63

For Example 1CF's URL, https://www.walmart.com/ip/Blinc-Eyebrow-Mousse-Auburn-4g-0-14oz/140383270

### Name1=Jewlzie

### Example 2.64

For Example 1CG's URL, https://www.walmart.com/ip/Blinc-Eyebrow-Mousse-Dark-Brunette-4g-0-14oz/103402597

### Name1=Jewlzie

### Example 2.65

For Example 1CH's URL, https://www.walmart.com/ip/Blinc-Mascara/726015057

### Name1=Cosmetic Mall

### Example 2.66

For Example 1CI's URL, https://www.walmart.com/ip/Blinc-Eyeliner-Pencil/465300883

### Name1=Cosmetic Mall

### Example 2.67

For Example 1CJ's URL, https://www.walmart.com/ip/Blinc-Eyeliner/702411263

### Name1=Cosmetic Mall

### Example 2.68

For Example 1CK's URL, https://www.walmart.com/ip/Eyebrow-Mousse/315630348

### Name1=Cosmetic Mall

### Example 3 (Building Alias1 in the Seller Aliasing Name Table)

For a stored URL, the computer revisits the URL at a later point in time and scrapes the Seller Name currently displayed. The computer compares the currently displayed seller name to Seller Name1 stored for the URL. If the names differ, the computer stores the new Seller Name as Alias1 in the Seller Aliasing Name Table for the URL. Particularly if the Seller Name is different at time2 than time1, the computer preferably stores an image of the webpage.

### Example 3.1

For URL https://www.walmart.com/ip/blinc-eyebrow-mousse-black/145850568,

### Name1=Primary Distribution

### Alias1=VivaBella

### Example 3.2

For URL https://www.walmart.com/ip/blinc-heated-lash-curler/182714321,

### Name1=Viva Bella

### Alias1=Union Square Limited

### Example 3.3

For URL https://www.walmart.com/ip/Blinc-Grey-Eyebrow-Mousse/111807094 (Example 1F),

### Name1=Primary Distribution

### Alias1=VivaBella

### Example 3.3

For Example 1G's URL https://www.walmart.com/ip/AsWeChange-Light-Tone-Blinc-Eye-Shadow-Primer/39572143,

### Name1=Union Square Limited

### Alias1=VivaBella

### Example 3.4

For URL https://www.walmart.com/ip/blinc-Lash-Primer-Black/155335568 (Example 1K),

### Name1=Union Square Limited

### Alias1=VivaBella

### Example 3.5

For URL https://www.walmart.com/ip/Blinc-Dark-Green-Mascara/105529977 (Example 1L),

### Name1=Fab Products LLC

### Alias1=VivaBella

### Example 3.6

For URL https://www.walmart.com/ip/Blinc-Mascara-Black-6g-0-21oz/133726291 (Example 10),

### Name1=Union Square Limited

### Alias1=Jewlzie

### Example 3.7

For Example 1Q's URL https://www.walmart.com/ip/AsWeChange-Blinc-Liquid-Eyeliner-Pen/44708512,

### Name1=Overstock

### Alias1=Cosmetics Online LLC

### Example 3.8

For Example 1R's URL, https://www.walmart.com/ip/AsWeChange-Medium-Brown-Blinc-Eyeliner/39571626,

### Name1=Fab Products LLC

### Alias1=Wide World of Beauty

### Example 3.9

For Example 1V's URL, https://www.walmart.com/ip/Blinc-Clear-Eyebrow-Mousse/116819674,

### Name1=Fab Products LLC

### Alias1=Overstock

### Example 3.10

For Example 1X's URL https://www.walmart.com/ip/AsWeChange-White-Blinc-Eyeliner-Pencil/44798494,

### Name1=Fab Products LLC Overstock

### Alias1=Overstock

### Example 3.11

For Example 1Y's URL https://www.walmart.com/ip/Blinc-Dark-Purple-Mascara/113193601,

### Name1=VivaBella

### Alias1=Fab Products, LLC

### Example 3.12

For URL https://www.walmart.com/ip/AsWeChange-Grey-Blinc-Eyeliner/39571722 (Example 1AG),

### Name1=VivaBella

### Alias1=Wide World of Beauty

### Example 4

The computer repeats the visits to the URL, the scraping of the current seller name, and the comparison of the current seller name against Name1 and/or Alias1, and if different, builds Alias2 into the Seller Aliasing Table.

### Example 4.1

For URL https://www.walmart.com/ip/AsWeChange-Blinc-Eyebrow-Mousse/112650512 (Example 1P),

### Name1=ShopXperts

### Alias1=Overstock

### Alias2=Fab Products, LLC

### Example 4.2

For Example 1AC's URL https://www.walmart.com/ip/AsWeChange-Blinc-Mascara-Amplified/46343021,

### Name1=Fab Products LLC

### Alias1=Cosmetics Online LLC

### Alias2=Simply Beauty Bar

### Example 4.3

For URL https://www.walmart.com/ip/Blinc-Dark-Blue-Mascara/149936276 (Example 1AH),

### Name1=Fab Products LLC

### Alias1=VivaBella

### Alias2=Overstock

### Alias3=VivaBella

### Example 4.4

For URL https://www.walmart.com/ip/AsWeChange-Black-Blinc-Eyeliner/39572230 (Example 1AI),

### Name1=Union Square Limited

### Alias1=Wide World of Beauty

### Alias2=Union Square Limited

### Example 4.5

For URL https://www.walmart.com/ip/Blinc-Long-Lash/130310489 (Example 1BF),

### Name1=ShopXperts

### Alias1=Face Etc.

### Alias2=Elizabeth Beauty

### Example 5

When the computer determines that a Name1 has a non-null entry for Alias1, an Aliasing Seller control # is assigned, and a table for the Aliasing Seller having that control # is created. Referring to Example 3.1, a table is created:

Aliasing Seller Control#=0001

Primary Distribution
VivaBella

### Example 5.1

When the computer detects that any family member within the control# has another Alias not already associated with the control#, the Aliasing seller table of Example 5 is updated. The computer continues to update the table of aliases for the Aliasing Seller Control# as more aliases are found for any member of that control#'s table, and whether found on the same URL or on other URLs, and whether for the same brand or a different brand, such as building the table of FIG. 1 in connection with Examples 3.1-3.41 and 4.1-4.5.

### Example 5.2

The computer builds tables for Aliasing Seller Control#1 . . . n. Sometimes a table will be built, such as for Control#5, when no relationship is then known between the aliases under Control#1 and Control#5, but later as the respective tables are further built, a commonality is found. In some embodiments and/or in some conditions, the computer merges the higher control# into the lower control#. For example, if the table for Control#1 and the table for Control#5 include aliases that back up to a common word in the source URL, and repeated overlaps and repeated common words in the respective source URLs are found, table-merging is favored.

In other embodiments and/or under other conditions, the computer builds the respective control# distinct tables without merging the tables. For example, if a table for Control#10 and a table for Control#1 include one overlap, but their respective source URLs lack a common shared brand name, possible merging might be deferred, such as until a shared brand name appears, or until there are at least 2 overlaps between the respective tables.

### Example 6

When a name appears in an Aliasing Seller table, such as the name Jewlzie, the computer undertakes URL-collecting for that seller name, and collects and stores more URLs to which Name1=Jewlzie is attributed:

https://www.walmart.com/ip/La-Mer-The-Moisturizing-Gel-Cream-60ml-2oz/162714032
https://www.walmart.com/ip/L-Oreal-Professionnel-Expert-Serie-Aminexil-Advanced-42x6ml-0-2oz/150579693
https://www.walmart.com/ip/Orlane-Creme-Royale-50ml-1-7oz/172246503
https://www.walmart.com/ip/Yves-Saint-Laurent-Terre-Saharienne-Bronzing-Powder-2-Copper-Sand-10g-0-35oz/144212300
https://www.walmart.com/ip/Estee-Lauder-Re-Nutriv-Ultimate-Lift-Age-Correcting-Creme-for-Throat-and-Decollectage-50ml-1-7oz/
143196874
https://www.walmart.com/ip/SK-II-Signs-Up-Lifter-40g-1-33oz/190453589
https://www.walmart.com/ip/Skin-Ceuticals-Biocellulose-Restorative-Masque-6sheets/151782738
https://www.walmart.com/ip/Acqua-Di-Parma-Rosa-Nobile-Leather-Purse-Spray-Eau-De-Parfum-20ml-0-7oz/148918451
https://www.walmart.com/ip/Fekkai-PrX-Reparatives-Argan-Extract-Conditioner-16-fl-oz/43454290
https://www.walmart.com/ip/Cameleon-MakeUp-Kit-396-48x-Eyeshadow-24x-Lip-Color-2x-Pressed-Powder-4x-Blusher-5x-Applicator/
185207799
https://www.walmart.com/ip/Urban-Decay-24-7-Glide-On-Waterproof-Eye-Pencil-Perversion-1-2g-0-04oz/875682947
https://www.walmart.com/ip/Lancome-Tresor-Eau-De-parfum-Spray-30ml-1oz/25968399
https://www.walmart.com/ip/BAXTER-OF-CALIFORNIA-HARD-CREAM-POMADE-60ML/174268565
https://www.walmart.com/ip/Lancome-Renergie-Multi-Lift-Lifting-Firming-Anti-Wrinkle-Night-Cream-50ml-1-7oz/119763034
https://www.walmart.com/ip/Estee-Lauder-Nutritious-Radiant-Vitality-Essence-Oil-30ml-1oz/136089224
https://www.walmart.com/ip/Estee-Lauder-Advanced-Night-Repair-Synchronized-Recovery-Complex-II-75ml-2-5oz/127132304
https://www.walmart.com/ip/Carol-s-Daughter-Loc-Butter-226g-8oz/109685612
https://www.walmart.com/ip/Carol-s-Daughter-Monoi-Repairing-Conditioner-226g-8oz/124440714
https://www.walmart.com/ip/ROC-Retinol-Correxion-Eye-Cream-15ml-0-5oz/190540905
https://www.walmart.com/ip/Orofluido-Beauty-Elixir-100ml-3-38oz/129994305
https://www.walmart.com/ip/Mario-Badescu-Facial-Spray-with-Aloe-Herbs-Rosewater-118ml-4oz/189533669
https://www.walmart.com/ip/Perricone-MD-Vitamin-C-Ester-Eye-Serum-15ml-0-5oz/131826251
https://www.walmart.com/ip/Clarins-Tonic-Body-Treatment-Oil-3-4-oz/51968690
https://www.walmart.com/ip/Cameleon-Make-Up-Kit-G1688-34xE-S-3xBlusher-2xPressed-Pwd-1xMascara-4xLipgloss-1xE-Pen-
4xApplicator/174683888
https://www.walmart.com/ip/Physiogel-Nutri-Hydratant-Quotidien-Shower-Cream-For-Dry-Sensitive-Skin-250ml-8-4oz/109538426
https://www.walmart.com/ip/Joico-Color-Endure-Violet-Shampoo-For-Toning-Blonde-Gray-Hair-1000ml-33-8oz/111887709
https://www.walmart.com/ip/Giorgio-Armani-Luminous-Silk-Foundation-5-5-Natural-Beige-30ml-1oz/110504321
https://www.walmart.com/ip/L-Oreal-Professionnel-Expert-Serie-Liss-Unlimited-Smoothing-Masque-For-Rebellious-Hair-500ml-16-9oz/
170087889
https://www.walmart.com/ip/Jurlique-Jasmine-Hand-Cream-125ml-4-3oz/124707270
https://www.walmart.com/ip/BareMinerals-Biolucent-Mineral-Brightening-Treatment-30ml-1oz/172258613
https://www.walmart.com/ip/Cameleon-MakeUp-Kit-G1697-1-25x-EyeShadow-4x-Compact-Powder-6x-Blusher-6x-Lipgloss-1x-Mascara/
182898517
https://www.walmart.com/ip/American-Crew-Men-3-in-1-Shampoo-Conditioner-Body-Wash-450ml-15-2oz/161409188
https://www.walmart.com/ip/Laura-Mercier-Loose-Setting-Powder-Translucent-29g-loz/110955808
https://www.walmart.com/ip/Clinique-Dramatically-Different-Moisturizing-Lotion-Very-Dry-to-Dry-Combination-Bottle-50ml-1-7oz/
106608791
https://www.walmart.com/ip/L-Occitane-Shea-Butter-Ultra-Rich-Body-Cream-200ml-7oz/182458096
https://www.walmart.com/ip/StriVectin-TL-Tightening-Body-Cream-200ml-6-7oz/137176982
https://www.walmart.com/ip/Byredo-Bal-D-Afrique-Eau-De-Parfum-Spray-100ml-3-4oz/185687744
https://www.walmart.com/ip/GloMinerals-Glopressed-Base-powder-Foundation-Honey-Light-9-9g-0-35oz/163670522
https://www.walmart.com/ip/Joico-Daily-Care-Leave-In-Detangler-For-All-Hair-Types-300ml-10-1oz/187815874
https://www.walmart.com/ip/Clarins-Lisse-Minute-Instant-Smooth-Perfecting-Touch-Makeup-Base-15ml-0-5oz/136933143
https://www.walmart.com/ip/Elizabeth-Arden-Visible-Difference-Refining-Moisture-Cream-Complex-75ml-2-5oz/149005846
https://www.walmart.com/ip/Cameleon-MakeUp-Kit-G1665-48xEyeshadow-4xBlush-6xLipgloss-4xBrush/138496843
https://www.walmart.com/ip/Kiehl-s-Ultra-Facial-Cream-125ml-4-2oz/138073071
https://www.walmart.com/ip/Giorgio-Armani-Master-Corrector-1-Pink-4-4ml-0-14oz/118287239
https://www.walmart.com/ip/Giorgio-Armani-Luminous-Silk-Foundation-5-Light-Beige-30ml-1oz/124544308
https://www.walmart.com/ip/Giorgio-Armani-Lasting-Silk-UV-Foundation-SPF-20-5-5-Natural-Beige-30ml-1oz/153030788
https://www.walmart.com/ip/Bliss-No-Zit-Sherlock-Complete-Acne-System-Purifying-Cleanser-Moisturizer-Serum-3pcs/170127569
https://www.walmart.com/ip/Goldwell-Curl-Love-2-Curl-Cream-150ml-5oz/145408558
https://www.walmart.com/ip/glominerals-GloBlush-Rosebud-0-12-oz/132731169
https://www.walmart.com/ip/American-Crew-Men-Classic-3-IN-1-Shampoo-Conditioner-Body-Wash-1000ml-33-8oz/134053362
https://www.walmart.com/ip/Giorgio-Armani-Luminous-Silk-Foundation-6-5-Tawny-30ml-1oz/153021951
https://www.walmart.com/ip/KMS-California-Hair-Stay-Clarify-Shampoo-Deep-Cleansing-To-Remove-Build-Up-300ml-10-1oz/114208710
https://www.walmart.com/ip/Dr-Hauschka-Eye-Balm-10ml-0-34oz/113276110
https://www.walmart.com/ip/NARS-Blush-Orgasm-4-8g-0-16oz/178934031
https://www.walmart.com/ip/L-Oreal-Professionnel-Homme-Mat-Matt-Sculpting-Pomade-80ml-2-7oz/107396370
https://www.walmart.com/ip/Rodial-Super-Acids-X-Treme-Acid-Rush-Pee1-50ml-1-7oz/137423838
https://www.walmart.com/ip/Toppik-Hair-Building-Fibers-Black-27-5g-0-97oz/115839424
haps://www.walmart.com/ip/L-Oreal-UV-Perfect-BB-Max-SPF-50-Advanced-12H-UV-Protector-30ml-1oz/131622727
etc.

### Example 6.1

Of course the computer also collects and stores URLs for other names shown in the table for Control#1, such as VivaBella, to which Name1=VivaBella is attributed:

https://www.walmart.com/ip/Bvlgari-Omnia-Crystalline-Gift-Set/198129794
https://www.walmart.com/ip/Bvlgari-Man-Bvlgari-3-4-oz-After-Shave-Balm-For-Men/111210096
https://www.walmart.com/ip/Obsession-Eau-De-Parfum-Spray-3-4-Oz/28564065
https://www.walmart.com/ip/Jay-Z-Gold-Jay-Z-Gift-Set-For-Men/156820170
https://www.walmart.com/ip/The-Art-Of-Shaving-Pre-Shave-Oil-Lemon-Oil-For-Men/130583010
https://www.walmart.com/ip/Mont-Blanc-Legend-by-Montblanc-for-Men-3-3-oz-EDT-Spray-Special-Edition/37653292
https://www.walmart.com/ip/Clean-for-Men-Shower-Fresh-2-14-oz-Eau-de-Toilette-Spray/158225550
https://www.walmart.com/ip/Wings-by-Giorgio-Beverly-Hills-for-Men-2-pc-Gift-Set-3-4oz-edt-Spray-3-4oz-after-shave/27653028
https://www.walmart.com/ip/Diesel-Zero-Plus-Feminine-For-Women/35905387
https://www.walmart.com/ip/Burberry-The-Beat-2-5-oz-EDT-Spray/52595227
https://www.walmart.com/ip/Egoiste-2-5-oz-After-Shave-Lotion/52074883
https://www.walmart.com/ip/Fresh-Cream-by-Philosophy-for-Women-2-oz/54732816
https://www.walmart.com/ip/Yacht-Man-Black-by-Myrurgia-for-Men-3-4-oz-EDT-Spray/28609584
https://www.walmart.com/ip/Fahrenheit-Cologne-Edc-Spray-For-Men/957456461
https://www.walmart.com/ip/Mont-Blanc-Legend-by-Montblanc-for-Men-3-Pc-Gift-Set-3-3oz-EDT-Spray-3-3oz-After-Shave-Balm-3-
3oz-All-Over-Shower-Gel/156176025
https://www.walmart.com/ip/Philosophy-Take-A-Deep-Breath-2-Ounce/186339368
https://www.walmart.com/ip/Fusio-Dose-Concentre-Oleo-Fusion-Intensive-Nutritive-Treatment-by-Kerastase-for-Unisex-15-X-0-4-oz/
52069453
https://www.walmart.com/ip/Penhaligon-s-14897514-Opus-1870-By-Penhaligon-s-Edt-Spray-3-4-Oz/44192737
https://www.walmart.com/ip/Royal-Treatment-Pearl-Complex-by-CHI-for-Unisex-6-oz-Leave-In-Treatment/34381688
https://www.walmart.com/ip/Advanced-Retinol-Night-Treatment-1-7-oz-Treatment/46343020
https://www.walmart.com/ip/M-Mariah-Carey-0-16-oz-EDP-Splash-For-Women/16094239
https://www.walmart.com/ip/Volume-2-Precision-Grace-by-Escentric-Molecules-for-Unisex-3-5-oz-EDT-Spray/142084774
https://www.walmart.com/ip/Mia-1-Facial-Sonic-Cleansing-System-Pink-by-Clarisonic-for-Unisex-4-Pc-Kit/54707269
https://www.walmart.com/ip/Aveda-Shampure-Dry-Shampoo-Refill-2-Oz/112065057
https://www.walmart.com/ip/K-Laque-Noire-Extra-Strong-Hold-by-Kerastase-for-Unisex-2-1-oz-Hair-Spray/174533333
https://www.walmart.com/ip/Taming-Curl-Cream-by-Macadamia-for-Unisex-5-oz-Cream/105815441
https://www.walmart.com/ip/St-Tropez-Self-Tan-Luxe-Dry-Facial-Oil-Tanner-For-Unisex/169263485
https://www.walmart.com/ip/Fekkai-Full-Blown-Volume-Citrus-Extract-Ginseng-Shampoo-16-fl-oz/43454264
https://www.walmart.com/ip/WhiteShoulders-by-Evyan-for-Women3-pc-Gift-Set-4-5oz-edc-Spray-3-3oz-body-lotion-7-5ML-Mini/46854897
https://www.walmart.com/ip/Pure-Poison-by-Dior-3-4-oz-EDP/27002794
https://www.walmart.com/ip/Pink-Sugar-Eau-De-Toilette-Roller-Ball-for-Women-0-34-oz/47711515
https://www.walmart.com/ip/FS4542P-Dean-Chronograph-Stainless-Steel-Watch-1-Pc-Watch/43457325
https://www.walmart.com/ip/White-Diamonds-Elizabeth-Taylor-Women-4-Pc-Gift-Set-3-3oz-EDT-Spray-3-3oz-Gentle-Moisturizing-
Body-Wash-3-3oz-Perfumed-Body-Lotion-10ml-EDT-Spray/144454756
https://www.walmart.com/ip/Light-Blue-Edt-Rollerball-For-Women/181642132
https://www.walmart.com/ip/Oscar-De-La-Renta-3945387-Oscar-By-Oscar-De-La-Renta-Body-Powder-5-2-Oz/48465755
https://www.walmart.com/ip/Peter-Thomas-Roth-Irish-Moor-Mud-Purifying-Cleansing-Gel-8-5-Ounce/125143841
https://www.walmart.com/ip/English-Lavender-by-Yardley-London-for-Women-4-2-oz/54732841
https://www.walmart.com/ip/Gucci-10280078-Premiere-By-Gucci-Eau-De-Parfum-Spray-1-Oz/42349459
https://www.walmart.com/ip/Thierry-Mugler-Angel-Muse-Eau-de-Parfum-for-Women-1-7-oz/647532576
etc.

### Example 7

The computer visits, over time, the URLs from Examples 6 and 6.1, and builds new tables when aliasing is found.

### Example 7.1 https://www.walmart.com/ip/Fekkai-PrX-Reparatives-Argan-Extract-Conditioner-16-fl-oz/43454290

### Name1=Jewlzie

### Alias1=CosmeticMall

### Example 7.2 https://www.walmart.com/ip/Urban-Decay-24-7-Glide-On-Waterproof-Eye-Pencil-Perversion-1-2g-0-04oz/875682947

### Name1=Jewlzie

### Alias1=SAI Holdings WW Inc

### Example 7.3 https://www.walmart.com/ip/BAXTER-OF-CALIFORNIA-HARD-CREAM-POMADE-60ML/174268565

### Name1=Jewlzie

### Alias1=Editor's Pick

### Example 7.4 https://www.walmart.com/ip/glominerals-GloBlush-Rosebud-0-12-oz/132731169

### Name1=Jewlzie

### Alias1=Apex Health & Beauty

### Example 7.5 https://www.walmart.com/ip/Bvlgari-Omnia-Crystalline-Gift-Set/198129794

### Name1=VivaBella

### Alias1=Overstock

### Example 7.6 https://www.walmart.com/ip/Bvlgari-Man-Bvlgari-3-4-oz-After-Shave-Balm-For-Men/111210096

### Name1=VivaBella

### Alias1=BloomingWay.com

### Example 7.7 https://www.walmart.com/ip/Mont-Blanc-Legend-by-Montblanc-for-Men-3-3-oz-EDT-Spray-Special-Edition/37653292

### Name1=VivaBella

### Alias1=WeMakeBeauty

### Example 7.8 https://www.walmart.com/ip/Clean-for-Men-Shower-Fresh-2-14-oz-Eau-de-Toilette-Spray/158225550

### Name1=VivaBella

### Alias1=Beauty Encounter

### Example 7.9 https://www.walmart.com/ip/Diesel-Zero-Plus-Feminine-For-Women/35905387

### Name1=VivaBella

### Alias1=Pharmapacks

### Example 7.10 https://www.walmart.com/ip/Burberry-The-Beat-2-5-oz-EDT-Spray/52595227

### Name1=VivaBella

### Alias1=PerfumesAmerica

### Example 7.11 https://www.walmart.com/ip/Yacht-Man-Black-by-Myrurgia-for-Men-3-4-oz-EDT-Spray/28609584

### Name1=VivaBella

### Alias1=MyFavoritePerfume.com

### Example 7.12 https://www.walmart.com/ip/Mont-Blanc-Legend-by-Montblanc-for-Men-3-Pc-Gift-Set-3-3 oz-EDT-Spray-3-3 oz-After-Shave-Balm-3-3 oz-All-Over-Shower-Gel/156176025

### Name1=VivaBella

### Alias1=Beauty Nuvo

### Example 7.13 https://www.walmart.com/ip/Philosophy-Take-A-Deep-Breath-2-Ounce/186339368

### Name1=VivaBella

### Alias1=EclickCentral

### Example 7.14 https://www.walmart.com/ip/Penhaligon-s-14897514-Opus-1870-By-Penhaligon-s-Edt-Spray-3-4-Oz/44192737

### Name1=VivaBella

### Alias1=SAI Holdings WW Inc

### Example 7.15 https://www.walmart.com/ip/Aveda-Shampure-Dry-Shampoo-Refill-2-Oz/112065057

### Name1=VivaBella

### Alias1=101beautystore

### Example 7.16 https://www.walmart.com/ip/Fekkai-Full-Blown-Volume-Citrus-Extract-Ginseng-Shampoo-16-fl-oz/43454264

### Name1=VivaBella

### Alias1=Elizabeth Beauty

### Example 7.17 https://www.walmart.com/ip/Pink-Sugar-Eau-De-Toilette-Roller-Ball-for-Women-0-34-oz/47711515

### Name1=VivaBella

### Alias1=Perfume Depot

### Example 7.18 https://www.walmart.com/ip/Oscar-De-La-Renta-3945387-Oscar-By-Oscar-De-La-Renta-Body-Powder-5-2-Oz/48465755

### Name1=VivaBella

### Alias1=Perfumes America

### Example 7.19 https://www.walmart.com/ip/English-Lavender-by-Yardley-London-for-W omen-4-2-oz/54732841

### Name1=VivaBella

### Alias1=PerfumesAmerica

### Example 7.20 https://www.walmart.com/ip/Thierry-Mugler-Angel-Muse-Eau-de-Parfum-for-Women-1-7-oz/647532576

### Name1=VivaBella

### Alias1=Pharmapacks

### Example 8

When the computer finds new aliases for Jewlzie or VivaBella such as in Examples 7.2, 7.3, 7.4, 7.6, 7.7, 7.8, 7.9, 7.10, 7.11, 7.12, 7.13, 7.14, 7.15, 7.17, 7.18, 7.19, 7.20, the table for Seller Aliasing Control#=0001 is updated, as shown in FIG. 1A.

### Example 9

Sometimes a URL is taken-over by Walmart, such as https://www.walmart.com/ip/M-Mariah-Carey-0-16-oz-EDP-Splash-For-Women/16094239 that had been used by VivaBella before being taken over by Walmart, i.e., the “sold and shipped by” text stopped displaying and any seller name stopped displayed, and the following began to be displayed: “Item Not Available” (in bold and large font), along with “Sold at Walmart store”, “In-store purchase only”, and “This item is only sold at a walmart store”.

### Example 9A

When the computer revisits a URL and finds that it has been taken over by Walmart (such as in Example 9), preferably the computer does not add an alias. Instead, preferably the computer builds a table of URLs taken-over by Walmart for that Aliasing Seller Control#.

### Example 10

When Name1 and Alias1 . . . n are constructed into a table, preferably the computer associates a date therewith.

### Example 10A https://www.walmart.com/ip/Blinc-Kiss-Me-Eyeliner-Color-Dark-Blue/146279187

| | | |
|---|---|---|
| Name1 | DealYard | Oct. 10, 2017 |
| Alias1 | Cyber Monday Specials | Oct. 20, 2017 |

### Example 10B https://www.walmart.com/ip/Blinc-Long-Lash/130310489

| | | |
|---|---|---|
| Name1 | ShopXperts | Jul. 11, 2017 |
| Alias1 | Face Etc. | Jul. 31, 2017 |
| Alias2 | Elizabeth Beauty | Sep. 13, 2017 |

### Example 10C https://www.walmart.com/ip/Blinc-Micro-Trimmer-Model-Le-717-Micro-Trimmer-For-Women/143004227

| | | |
|---|---|---|
| Name1 | Fab Products LLC | Jul. 11, 2017 |
| Alias1 | DealYard | Oct. 20, 2017 |
| Alias2 | BuyDBest Incorporated | Nov. 03, 2017 |

What I claim as my invention is:

1. A method of exposing walmart.com sellers who are selling counterfeit, expired and/or stolen product and webpages with nefarious selling, comprising steps each performed by a computer:
collecting walmart.com URLs for webpages on which a product is sold and a Seller/Shipper name is displayed,
storing the collected URLs,
for a URL collected and stored, scraping the Seller/Shipper Name from the URL and using the scraped name as Name1 to begin a Seller Aliasing Table,
for a stored URL, revisiting the URL at a later point in time and scraping the Seller/Shipper Name currently displayed, followed by comparing the currently displayed Seller/Shipper name to Seller Name1 stored for the URL.

2. The method of claim 1, wherein, in the comparing step, if the names differ, storing the new Seller Name as Alias1 in the Seller Aliasing Name Table for the URL.

3. The method of claim 2, wherein if the Seller Name is different at time2 than time1 on a URL, storing an image of the webpage.

4. The method of claim 2, further comprising repeating the visiting the URL and the scraping of the current seller name, and comparing the now-current seller name against Name1 and/or Alias1, and if different, building Alias2 into the Seller Aliasing Table.

5. The method of claim 2, further comprising, when the computer determines that a Name1 has a non-null entry for Alias1, assigning an Aliasing Seller control # and populating a table for the Aliasing Seller having that control #.

6. The method of claim 1, operated in conjunction with an app useable by shoppers whereby a device of the shopper submits to the computer a URL on which the shopper is contemplating a purchase transaction, and the computer communicates a message to the device of the shopper about the URL and/or the seller name displayed on the URL.

7. The method of claim 6, wherein for a URL that has stored therefor at least one alias Alias1 . . . n in addition to Name1, the communicated message is a warning.

8. The method of claim 6, wherein the computer performs scraping of the seller name from the URL on which the shopper is contemplating a purchase transaction in order, followed by comparing the scraped seller name against stored aliasing records, and if the scraped seller name is found in an aliasing table, communicating a warning message to the device of the shopper.

9. The method of claim 1, further comprising operating a portal into which is received a seller name being queried by a brand owner or other interested party in a querying step, and in response to the querying step, outputting a list of aliases for the seller name being queried.

10. The method of claim 1, further comprising operating a portal into which are received repudiation reports submitted by a brand owner, wherein the repudiation report comprises a brand name and at least one website for which the brand owner repudiates purported sales.

11. The method of claim 10, further comprising the computer's processing the repudiation report into a warning communication delivered to at least one shopper.

12. The method of claim 11, wherein the warning communication is in a format “this brand isn't sold on walmart.com”.
